(19) United States
(12) Patent Application Publication
(10) Pub. No.: US 2009/0052071 A1
(43) Pub. Date: Feb. 26, 2009

(54) Rear-view mirror assembly

(76) Inventor: Jung-Hua Chang, Taoyuan (TW)

Correspondence Address: SAM CHEN, 7F-1, 293, ROOSEVELT ROAD, SEC 3, TAIPEI, TW

(21) Appl. No.: 11/844,335

(22) Filed: Aug. 23, 2007

(51) Int. Cl. B60R 1/08

(52) U.S. Cl. 359/839; 361/681

(57) ABSTRACT

A rear-view mirror assembly includes a housing having a receiving space defined therein. The receiving space is provided to receiving elements of the rear-view mirror assembly and a digital device. A multi-functional lens is attached to the housing for selectively closing the receiving space. The multi-functional lens can flash back the objects and become transparent when a light source is turn on behind the multi-functional lens. A holder is mounted in the housing for holding the digital device in place. A fix unit is formed on an outer periphery of the housing for mounted the housing to a frame of a motorcycle or a bicycle.

### BACKGROUND OF THE INVENTION

1. Field of the Invention

The present invention relates to a rear-view mirror assembly, and more particularly to a rear-view mirror assembly that can contain a digital device therein.

2. Description of Related Art

In the 21 century, we all live in a digital times. Many conventional articles and apparatus are replaced by digital products or high technology products, such as a GPS system can indicate the right route to the destination, a mobile phone can provide a long distance communication, a PDA can help you to handle many personal routine works and the digital AV system (Ipod, Mp3 player) can save and play a large number of AV signal.

The above digital products usually are wireless and has a LCD displayer for convenient operation. In addition, these digital products are widely used in a vehicle for promoting driving amusement or indicate a right route to the destination. Furthermore, the user even can handle his/her personal routine works outdoors.

However, the traffic condition becomes more and more crowded in cities. Consequently, many drivers select a motorcycle or a bicycle as his/her traffic instrument. A conventional motorcycle or bicycle has no suitable position to install these digital products to provide digital services to the rider.

The present invention has arisen to mitigate and/or obviate the disadvantages of the conventional motorcycle or bicycle without a suitable position for install digital products.

### SUMMARY OF THE INVENTION

The main objective of the present invention is to provide an improved rear-view mirror assembly that can stably receive a digital device therein.

To achieve the objective, the rear-view mirror assembly in accordance with the present invention comprises a housing having a receiving space defined therein. The receiving space is provided to receiving elements of the rear-view mirror assembly and a digital device. A multi-functional lens is attached to the housing for selectively closing the receiving space. The multi-functional lens can flash back the objects and become transparent when a light source is turn on behind the multi-functional lens. A holder is mounted in the housing for holding the digital device in place. A fix unit is formed on an outer periphery of the housing for mounted the housing to a frame of a motorcycle or a bicycle.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a rear-view mirror assembly in accordance with the present invention;

FIG. 2 is a perspective view of the rear-view mirror assembly in accordance with the present invention;

FIG. 3 is a perspective view of the rear-view mirror assembly of the present invention when the digital device in mounted therein;

FIG. 4 is a front plan view of the rear-view mirror assembly of the present invention when the digital device is turn off; and

FIG. 5 is a front plan view of the rear-view mirror assembly of the present invention when the digital device is turn on.

### DETAILED DESCRIPTION OF THE INVENTION

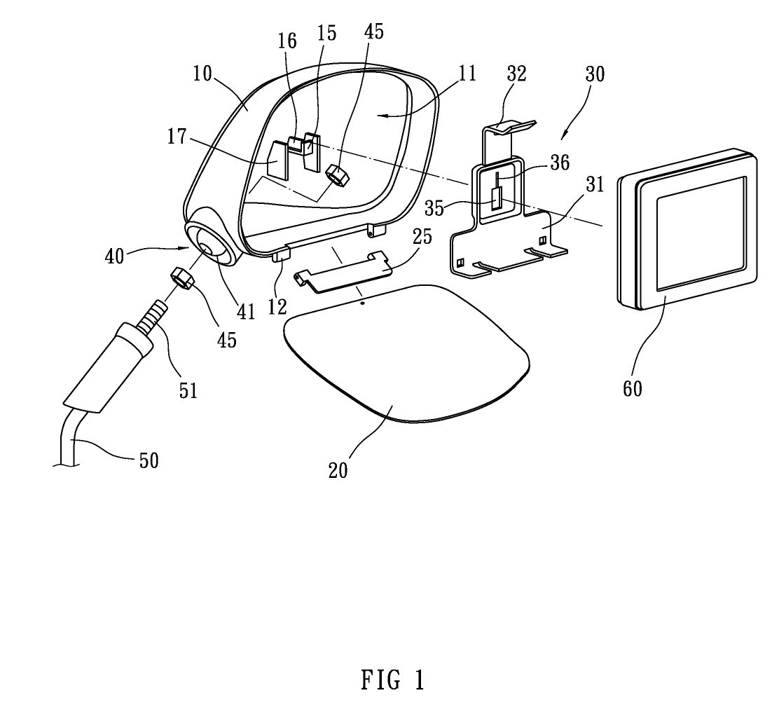

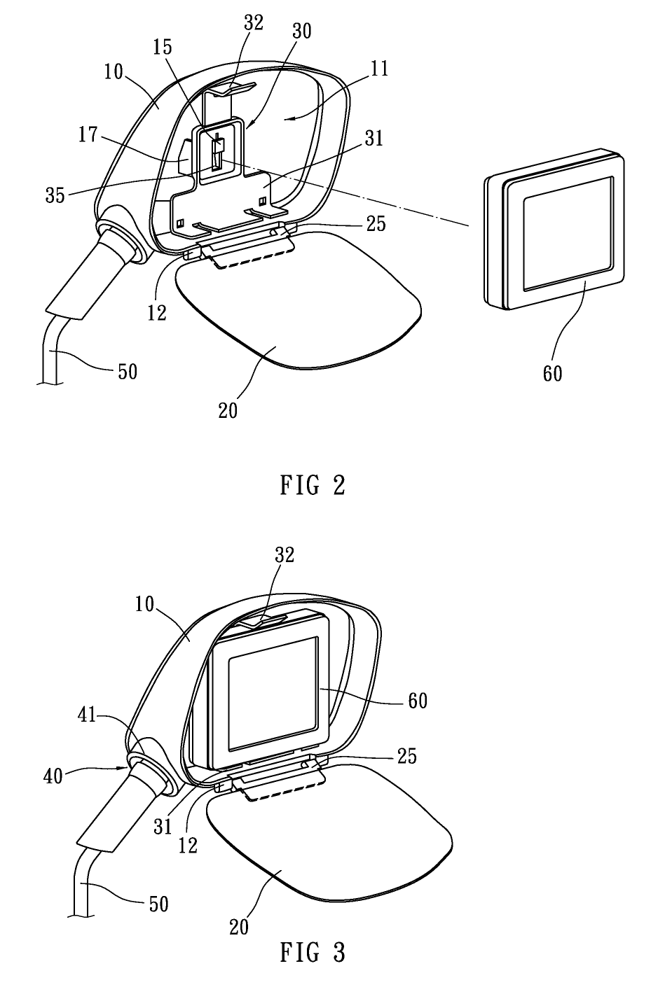

Referring to the drawings and initially to FIGS. 1 and 2, a rear-view mirror assembly in accordance with the present invention comprises housing (10), a multi-functional lens (20) pivotally mounted to the housing (10), a holder (30) mounted in the housing (10) adapted to hold a digital device (60) and a fix unit (40) formed on one side of the housing (10) for connecting the housing (10) to a frame (50) of a motorcycle or a bicycle.

Further with reference to FIG. 3, a receiving space (11) is laterally defined in the housing (10) and defines an opening (not numbered). A pair of protrusions (12) extends from a bottom of the housing (10). An L-shaped buckle (15) extends from a bottom of the receiving space (11) and a fastener (16) upwardly extends from a horizontal portion of the buckle (15). A pair of stoppers (17) laterally extends from the bottom of the receiving space (11) and the buckle (15) is located within the pair of stoppers (17).

A pivot seat (25) is pivotally mounted to the pair of protrusions (12) and the multi-functional lens (20) is connected to the pivot seat (25) such that the multi-functional lens (20) can selectively close the receiving space (11) in the housing (10) via the pivot relation between the pair of protrusions (12) and the pivot seat (25). The multi-functional lens (20) can flash back the objects after the motorcycle/bicycle and become transparent when a light source is turn on behind the multi-functional lens (20).

The holder (30) includes an L-shaped carrier (31) and an inverse L-shaped resilient plate (32) is disposed on a top of the carrier (31). The height of the resilient plate (32) relative to the carrier (31) can be adjusted to clamp different digital devices (60). A square through hole (35) is defined in a vertical portion of the L-shaped carrier (31) and a slit (36) is defined in the vertical portion of the L-shaped carrier (31). The square through hole (35) has a width greater than that of the slit (36).

When mounting the holder (30), the buckle (15) extends through the square through hole (35) in the carrier (31) and then downward moves the holder (30) to make the fastener (16) be received in the slit (36), and the vertical portion of the carrier (31) is located between the pair of stoppers (17). Consequently, the fastener (16) and the pair of stoppers (17) can prevent the holder (30) from being rocked relative to the housing (10).

The fix unit (40) is formed on an outer periphery of the housing (10). The fix unit (40) has hemisphere pedestal (41) protruded from the outer periphery of the housing (10). When mounting the housing (10), the frame (50) has a threaded portion (51) formed on a free end thereof and extending through the hemisphere pedestal (41). Two nuts (45) are respectively screwed onto the threaded portion (51) to securely clamp the housing (10) on the frame (50).

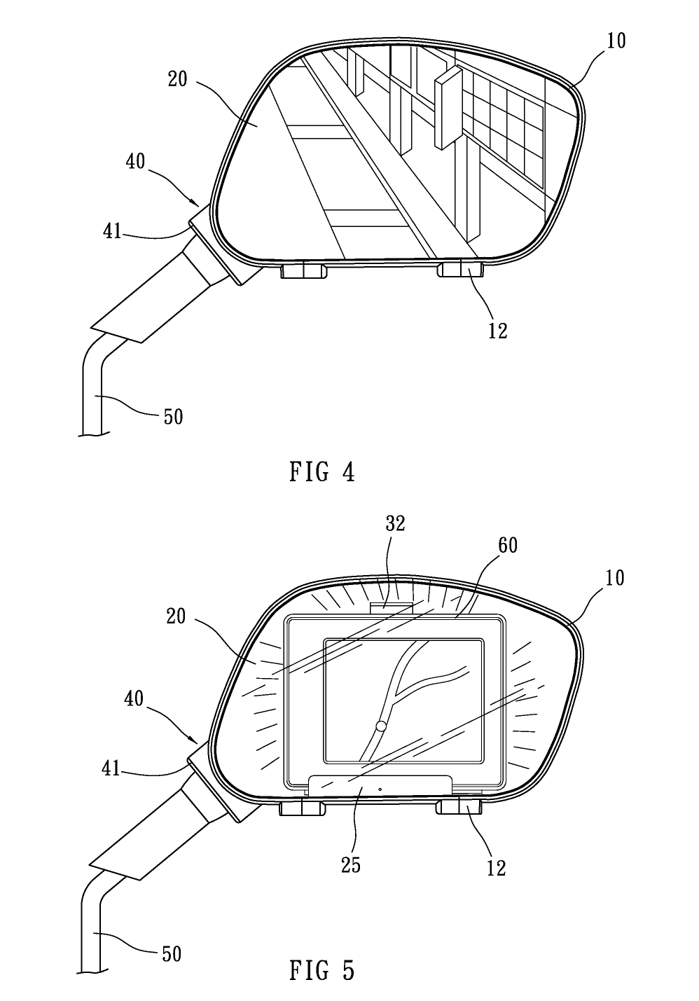

With reference to FIGS. 2-5, the receiving space (11) is opened due to the pivot relation between the multi-functional lens (20) and the housing (10). The digital device (60) is clamped between the carrier (31) and the resilient plate (32). The multi-functional lens (20) closes the receiving space (11) again after the digital device (60) being well installed. Consequently, the digital device (60) not only does not occupy space but also is well hided in the rear-view mirror assembly in accordance with the present invention. As shown in FIG. 4, the multi-functional lens (20) can flash back the objects after the motorcycle/bicycle when the digital device (60) is turn off.

As shown in FIG. 5, the light ray from the digital device (60) penetrates the multi-functional lens (20) when the digital device (60) is turn on. As a result, the rider can see the data or information from the digital device (60), such as indicating a right route or providing AV amusements effect.

Although the invention has been explained in relation to its preferred embodiment, it is to be understood that many other possible modifications and variations can be made without departing from the spirit and scope of the invention as hereinafter claimed.

What is claimed is:

1. A rear-view mirror assembly comprising:
a housing having a receiving space defined therein, the receiving space provided to receiving elements of the rear-view mirror assembly and a digital device;
a multi-functional lens attached to the housing for selectively closing the receiving space, the multi-functional lens flashing back the objects and becoming transparent when a light source is turn on behind the multi-functional lens;
a holder mounted in the housing and adapted to hold the digital device in place; and
a fix unit formed on an outer periphery of the housing for mounted the housing to a frame.

2. The rear-view mirror assembly as claimed in claim 1, wherein the housing includes a pair protrusion extending from the housing, a pivot seat pivotally mounted to the pair of protrusions and the multi-functional lens connected to the pivot seat.

3. The rear-view mirror assembly as claimed in claim 1, wherein holder includes an L-shaped carrier and an inverse L-shaped resilient plate disposed on a top of the carrier, the height of the resilient plate relative to the carrier being adjusted.

4. The rear-view mirror assembly as claimed in claim 3, wherein the housing includes an L-shaped buckle extending from a bottom of the receiving space and a fastener upwardly extending from a horizontal portion of the buckle, and the L-shaped carrier includes a square through hole defined in a vertical portion of the L-shaped carrier and a slit defined in the vertical portion of the L-shaped carrier, the square through hole having a width greater than that of the slit, when mounting the holder, the buckle extending through the square through hole in the carrier and then downward moving the holder to make the fastener be received in the slit.

5. The rear-view mirror assembly as claimed in claim 4, wherein the housing has a pair of stoppers laterally extending from the bottom of the receiving space and the buckle being located within the pair of stoppers, the vertical portion of the carrier located between the pair of stoppers to prevent the holder from being rocked relative to the housing.

6. The rear-view mirror assembly as claimed in claim 2, wherein holder includes an L-shaped carrier and an inverse L-shaped resilient plate disposed on a top of the carrier, the height of the resilient plate relative to the carrier being adjusted.

7. The rear-view mirror assembly as claimed in claim 6, wherein the housing includes an L-shaped buckle extending from a bottom of the receiving space and a fastener upwardly extending from a horizontal portion of the buckle, and the L-shaped carrier includes a square through hole defined in a vertical portion of the L-shaped carrier and a slit defined in the vertical portion of the L-shaped carrier, the square through hole having a width greater than that of the slit, when mounting the holder, the buckle extending through the square through hole in the carrier and then downward moving the holder to make the fastener be received in the slit.

8. The rear-view mirror assembly as claimed in claim 7, wherein the housing has a pair of stoppers laterally extending from the bottom of the receiving space and the buckle being located within the pair of stoppers, the vertical portion of the carrier located between the pair of stoppers to prevent the holder from being rocked relative to the housing.
